(19) United States
(12) Patent Application Publication
(10) Pub. No.: US 2005/0146202 A1
(43) Pub. Date: Jul. 7, 2005

(54) Wheel frame re-equipping mechanism with a rotatable blade

(76) Inventor: Rocky Lin, Taipei (TW)

Correspondence Address: ROCKY LIN, P.O. BOX 26-757, TAIPEI, R.O.C. 106, TW

(21) Appl. No.: 10/753,998

(22) Filed: Jan. 6, 2004

(51) Int. Cl. B60B 7/04

(52) U.S. Cl. 301/37.25

(57) ABSTRACT

A wheel frame re-equipping mechanism includes a wheel frame assembly, blade member pivotally connected to the wheel frame assembly, a ratchet member having a plurality of unidirectional teeth formed at an outer circumference thereof and an abutting member abutting against one of the unidirectional teeth of the ratchet member. The ratchet member and the abutting member are arranged between the wheel frame and the blade member. Furthermore, the blade member will be able to be simultaneously rotated through a wheel or a wheel frame in car to proceed, and it still can be continuously rotated in a while after the car is decelerated to stop.

### BACKGROUND OF THE INVENTION

1. Field of the Invention

The present invention relates to a wheel frame re-equipping mechanism with a rotatable blade and, more particularly to a wheel frame re-equipping mechanism having a blade member pivotally connected to a wheel frame cap or a wheel frame connection seat on a wheel frame. The blade member not only can provide a forward driving effect in car to proceed, but also can be continuously rotated in a while after the car is decelerated to stop.

2. Description of the Related Art

In general, a conventional blade coaxially arranged on the wheel frame is formed of a metallic material with a great weight, such as an aluminum alloy material. It provides an object in that the blade can be rotated in car to proceed, and it still can be continuously rotated due to an inertia principle within a while after the car is decelerated to stop.

In order to reduce cost and prevent weight of the blade re-equipped into the wheel frame cap or wheel from exceeding a predetermined value, thus most blades are manufactured by plastic material. However, due to too light plastic blade, it will be arbitrarily rotated in forward or contrary direction, and fail to be continuously rotated in any external rotated power. Besides, in the car to proceed, it will cause the blade to swing due to airflow coming from multiple directions, thereby failing to effectively drive the blade to rotate.

### SUMMARY OF THE INVENTION

It is therefore a principal object of the invention to provide a wheel frame re-equipping mechanism having a blade member in that the blade member will be able to be simultaneously rotated through a wheel or a wheel frame in car to proceed, and it still can be continuously rotated in a while after the car is decelerated to stop. Furthermore, the present invention has been accomplished to eliminate the aforesaid problem, such as the over-light blade which will be rotated in arbitrary direction.

To achieve the above object, the present invention provides a wheel frame re-equipping mechanism adapted for a wheel frame. The wheel frame re-equipping mechanism includes a wheel frame assembly, a blade member, a ratchet member and an abutting member. The wheel frame assembly is arranged on the wheel frame. The blade member is pivotally connected to the wheel frame assembly. The ratchet member has a plurality of unidirectional teeth formed at an outer circumference thereof The abutting member can abuts against one of the unidirectional teeth of the ratchet member. The ratchet member and the abutting member are arranged between the wheel frame and the blade member.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective exploded view of a first embodiment of a wheel frame re-equipping mechanism of the present invention;

FIG. 2 is a perspective view of the first embodiment of the wheel frame re-equipping mechanism of the present invention;

FIG. 3 is a view for explaining a planar movement of FIG. 2 in a unidirectional rotatable condition;

FIG. 3A is a partially enlarged view of “A” part of FIG. 3;

FIG. 4 is a view for explaining a planar movement of FIG. 2 in a reversing and stopped condition;

FIG. 5 is a view for explaining a condition to show another arrangement of the ratchet member and the abutting member of the first embodiment of the present invention;

FIG. 6 is a perspective exploded view of the second embodiment of a wheel frame re-equipping mechanism of the present invention; and

FIG. 7 is a view for explaining a condition to show another arrangement of the ratchet member and the abutting member of the second embodiment of the present invention.

### DETAILED DESCRIPTION OF THE EMBODIMENTS

Wherever possible in the following description, like reference numerals will refer to like members and parts unless otherwise illustrated.

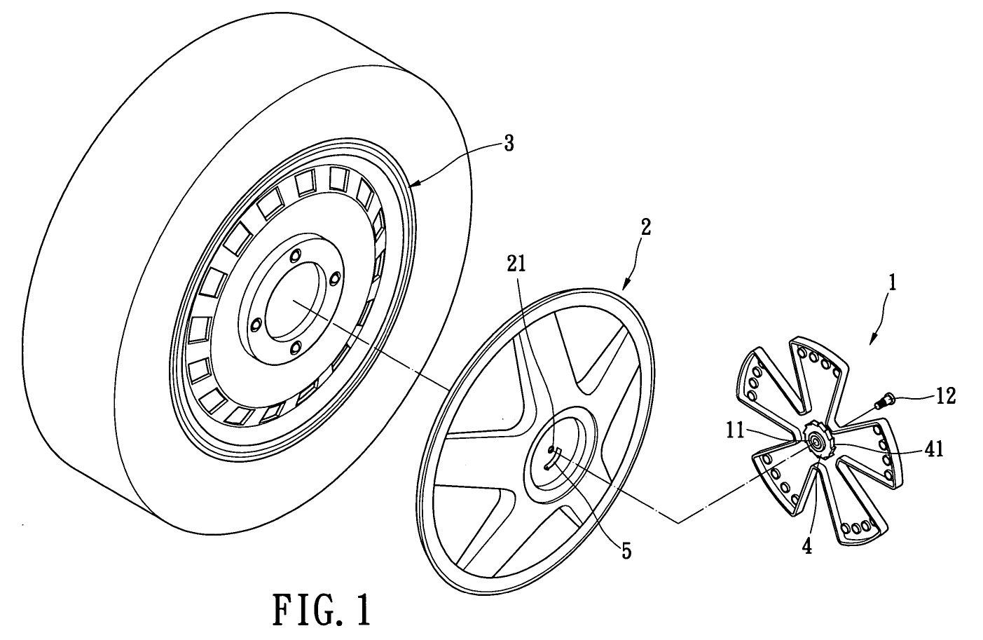

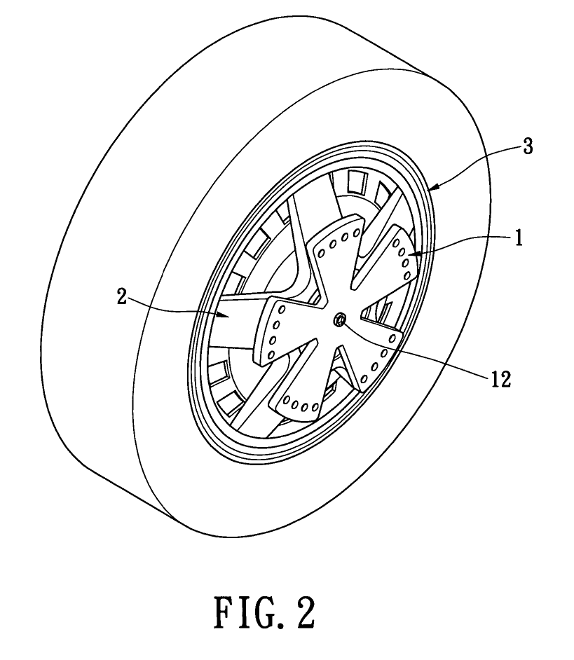

With reference to FIGS. 1 to 7, the present invention provides a wheel frame re-equipping mechanism including a wheel frame assembly, a blade member 1, a ratchet member 4 and an abutting member 5.

The present invention has at least two different embodiments. In a first embodiment, the ratchet member 4 is arranged on the blade member 1, and the abutting member 5 is arranged on the wheel frame assembly that can be a wheel frame cap 2 installed on one side of a wheel frame 3 (generally named as an iron frame). In a second embodiment, the ratchet member 4 is arranged on the wheel frame assembly that can be a wheel frame connection seat 8, and the abutting member 5 is arranged on the blade member 1 installed on an axial position of a wheel frame 7 (generally named as an aluminum frame).

The first embodiment of the present invention is shown in FIGS. 1-5. The blade member 1 is formed by plastic material, and has a bearing 11 arranged at an axial position of an inner side thereof. The ratchet member 4 is coaxially arranged at an outer circumference of the bearing 11, so that the ratchet member 4 can be simultaneously rotated with the blade member 1. The ratchet member 4 has a plurality of unidirectional teeth 41 formed at an outer circumference thereof as an outer-tooth type of ratchet.

The wheel frame cap 2 has a fastening hole 21 arranged at an axial position of an outer side thereof. The abutting member 5 (such as an elastic piece or an elastic body) is arranged at an eccentric position of the wheel frame cap 2.

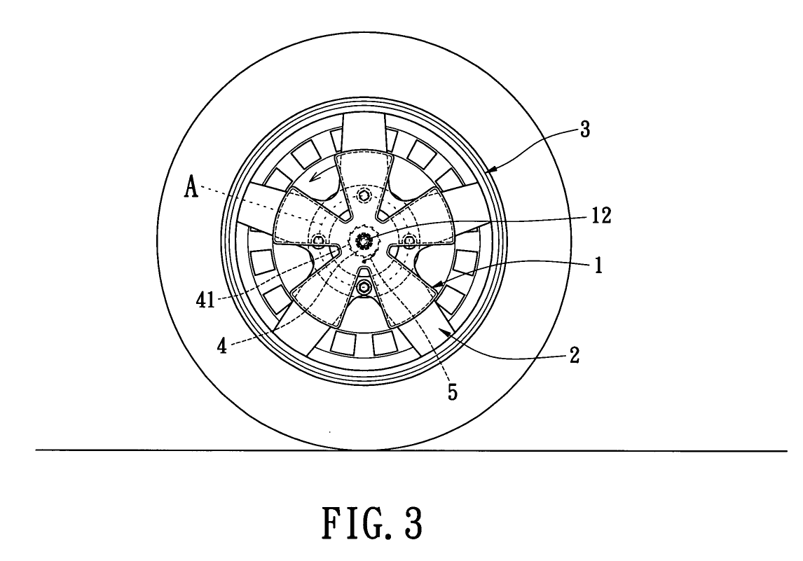

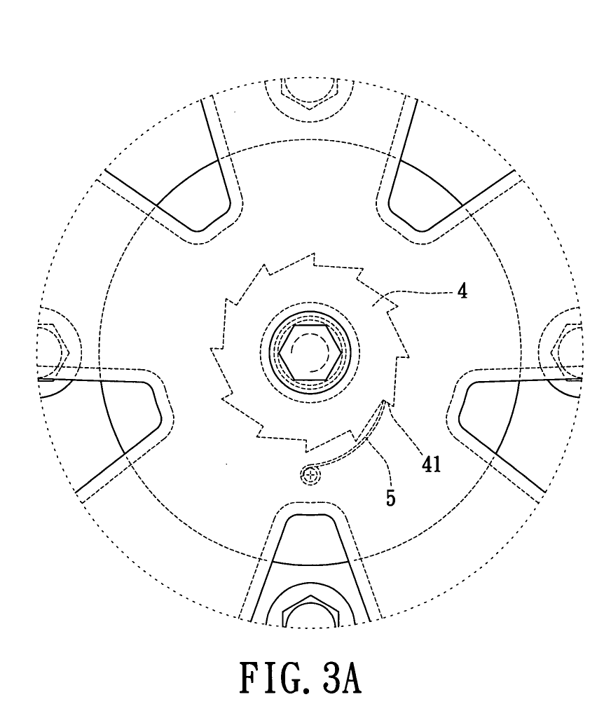

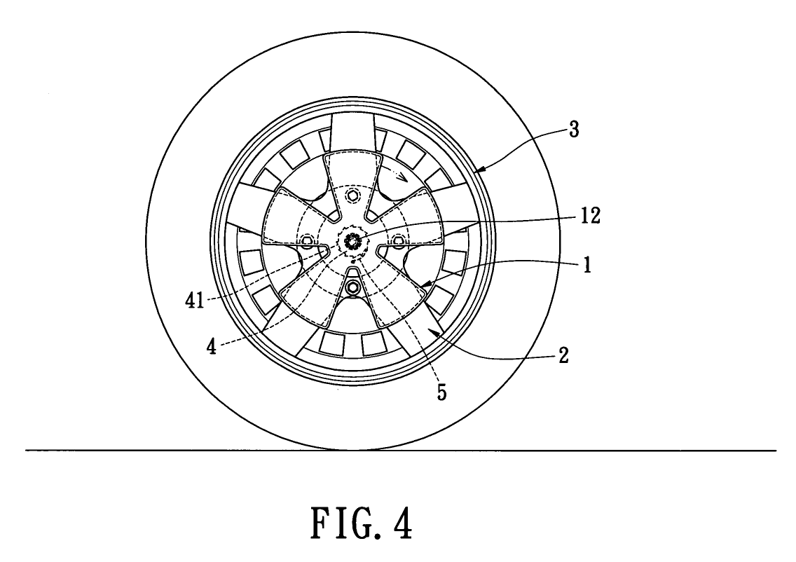

The blade member 1 is pivotally connected to the axial position of the wheel frame cap 2. In a connection manner, the fastening element 12 sequentially passes through the blade member 1 and the bearing 11 for connecting within the fastening hole 21 of the wheel frame cap 2. The blade member I can be rotated relative to the fastening element 12 as an axis. The abutting member 5 has a free end to abut against the unidirectional teeth 41 in order to produce a reverse-preventing function, so that the blade member 1 only can be unidirectionally rotated (shown in FIG. 3 and FIG. 3A), but not be reversedly rotated (shown in FIG. 4). Furthermore, in the car to proceed, the blade member 1 can achieve a forward driving effect (shown in FIG. 3A, the abutting member 5 forward drives the unidirectional teeth 41 of the ratchet member 4, or the unidirectional teeth 41 of the ratchet member 4 forward drives the abutting member 5), a simultaneously driving effect and a reverse-preventing effect. In the car decelerated to stop, the blade member 1 can achieve continuously rotated effect through the original rotated power, the forward-directional ratchet teeth, and the freely rotatable bearing 11. The blade member 1 of the present invention can be simultaneously rotated with the car wheel or the wheel frame due to a forward driving external force.

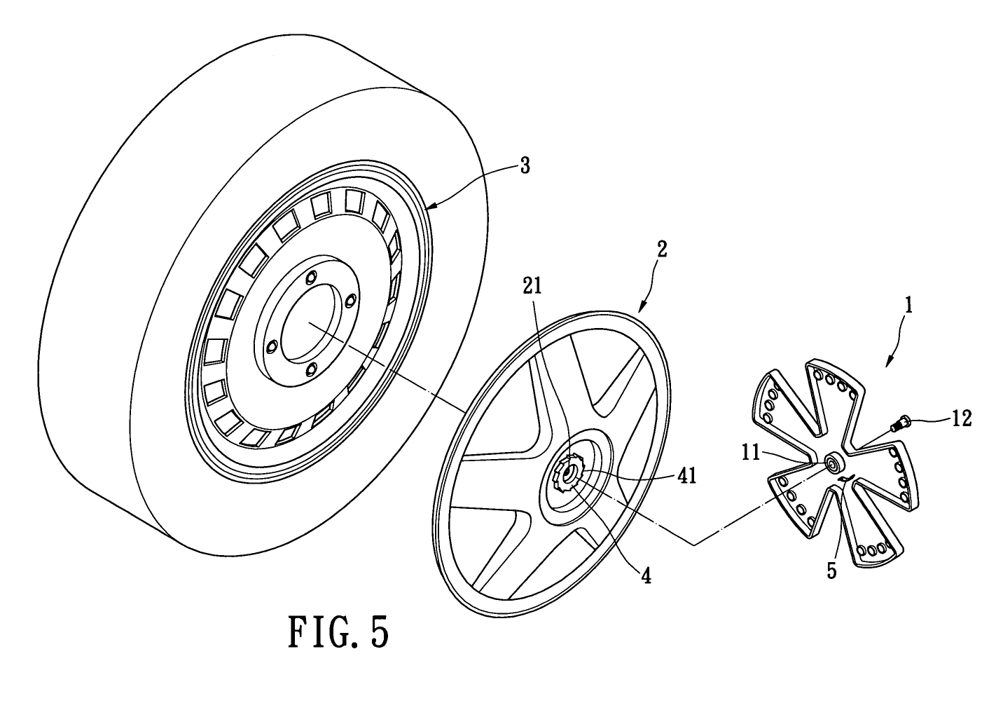

In addition, FIG. 5 shows another arrangement of the ratchet member 4 and the abutting member 5. The ratchet member 4 is arranged on an outer side of the wheel frame cap 2, and the abutting member 5 is arranged on an inner side of the blade member 1.

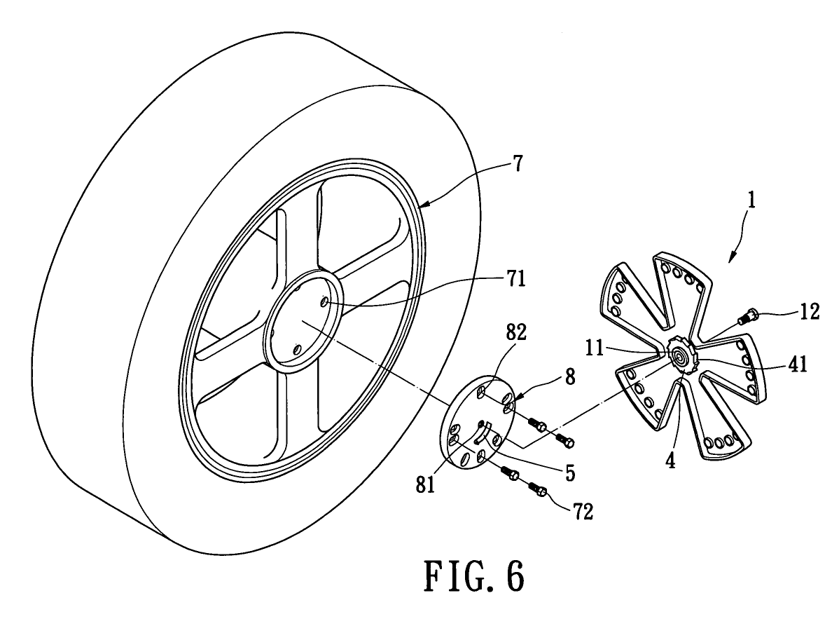

The second embodiment of the present invention is shown in FIG. 6. The ratchet member 4 and the abutting member 5 of the second embodiment are the same as that of the first embodiment, and the ratchet member 4 still is arranged on the inner side of the blade member 1. In different, the abutting member 5 is arranged on the side of the wheel frame connection seat 8, and the wheel frame connection seat 8 is fastened on the axial position of the outer side of the wheel frame 7.

The wheel frame connection seat 8 has a fastening hole 81 arranged at an axial position thereof and a plurality of slits 82 arranged at an eccentric position thereof. A plurality of fastening elements 72 are penetrated through the slits 82, respectively, to fix within the according fastening holes 71 of the wheel frame 7. Thus the wheel frame connection seat 8 can be fixed at the axial position of the outer side of the wheel frame 7. Further, the fastening element 12 is fixed to the fastening hole 8 1, so that the blade member I can be pivotally connected to the wheel frame connection seat 8 for simultaneously rotating with the wheel frame 7.

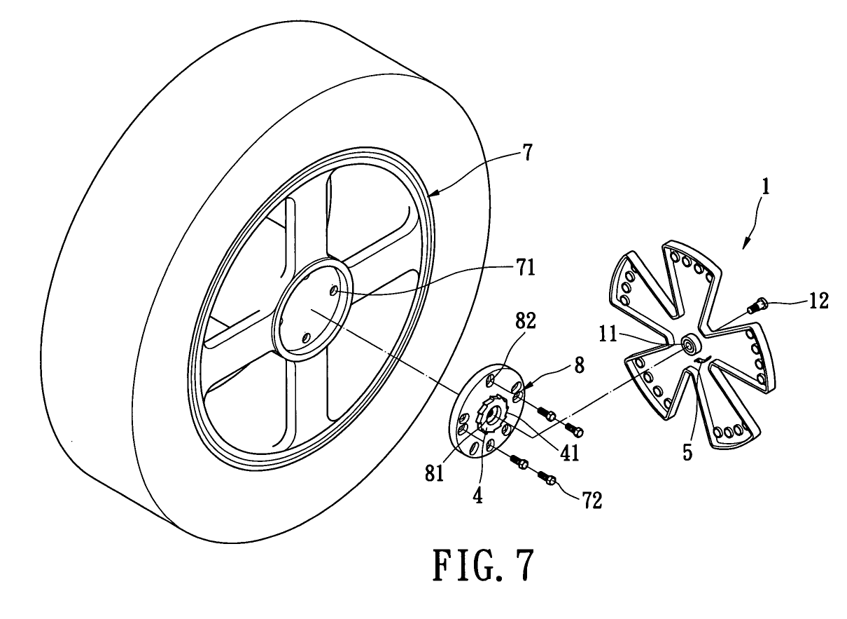

In addition, FIG. 7 shows another arrangement of the ratchet member 4 and the abutting member 5. The ratchet member 4 is arranged on the side of the wheel frame connection seat 8, and the abutting member 5 is arranged on the inner side of the blade member 1.

As described above, according to any embodiment of the present invention, in the car to proceed, the blade member 1 can achieve the forward driving effect, the simultaneously driving effect and the reverse-preventing effect, and in the car decelerated to stop, the blade member 1 can achieve the continuously rotated effect. Therefore; even if the blade member 1 is made by a plastic material to be over-light, it still can be rotated in the car to proceed (yet not like the conventional product whose rotated effect is limited because the blade fails to be effectively forward driven), and further it still can be continuously rotated in a while after the car is decelerated to stop. Furthermore, it will produce clear and melodious sound to attract passersby's attention because of the unidirectional teeth 41 knocked with the abutting member 5.

There has thus been described a new, novel and heretofore unobvious a wheel frame re-equipping mechanism which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

1. A wheel frame re-equipping mechanism adapted for a wheel frame, comprising:
a wheel frame assembly arranged on the wheel frame;
a blade member pivotally connected to the wheel frame assembly;
a ratchet member having a plurality of unidirectional teeth formed at an outer circumference thereof; and
an abutting member for abutting against one of the unidirectional teeth of the ratchet member; wherein the ratchet member and the abutting member are arranged between the wheel frame and the blade member.

2. The wheel frame re-equipping mechanism of claim 1, wherein the ratchet member is arranged on the blade member, and the abutting member is arranged on the wheel frame assembly.

3. The wheel frame re-equipping mechanism of claim 1, wherein the ratchet member is arranged on the wheel frame assembly, and the abutting member is arranged on the blade member.

4. The wheel frame re-equipping mechanism of claim 1, wherein the wheel frame assembly is a wheel frame cap.

5. The wheel frame re-equipping mechanism of claim 1, wherein the wheel frame assembly is a wheel frame connection seat.

6. The wheel frame re-equipping mechanism of claim 5, wherein the wheel frame connection seat is fastened on an axial position of one side of the wheel frame.
